(19) United States
(12) Patent Application Publication
(10) Pub. No.: US 2016/0021193 A1
(43) Pub. Date: Jan. 21, 2016

(54) METHOD OF AUTOMATICALLY CLOSING AN APPLICATION ON TRANSPORT DISCONNECT

(71) Applicant: MYINE ELECTRONICS, INC., Ferndale, MI (US)

(72) Inventors: Joel J. FISCHER, Royal Oak, MI (US); Joey Ray GROVER, Madison Heights, MI (US); Michael BURKE, Detroit, MI (US); Philip J. DANNE, Royal Oak, MI (US)

(21) Appl. No.: 14/332,977

(22) Filed: Jul. 16, 2014

(51) Int. Cl. H04L 29/08; H04L 12/26

(52) U.S. Cl. CPC H04L 67/143; H04L 43/10; H04L 67/10

(57) ABSTRACT

A computer readable storage medium, storing instructions, which, when executed by a processor, cause the processor to perform a shutdown method for one or more applications. The method may comprise monitoring a communication link with a vehicle computing system. The method may further comprise transmitting a termination message based upon detecting a disconnection of the communication link. The termination message includes instructions to shutdown the one or more applications utilizing the communication link.

### TECHNICAL FIELD

The present disclosure relates to the implementation of applications operating within a nomadic device and communicated to a vehicle computing system.

### BACKGROUND

U.S. Pat. No. 6,779,047 generally discloses arbitration software operating on a computer to determine whether communication software utilizes the same serial communication (COM) port of the computer as a HotSync Manager. If the same serial COM port is used, the arbitration software shuts down the HotSync Manager. If the arbitration software is running, the serial COM port may be utilized for other purposes (e.g., wireless modem communication). However, if the arbitration software detects a HotSync Request received via the serial COM port, it runs the HotSync Manager enabling a HotSync process to occur between (for example) a personal digital assistant (PDA) and the computer. Once the arbitration software detects the completion of the HotSync process, it shuts down the HotSync Manager until it detects the next HotSync Request.

U.S. Patent Application 2006/0277275 generally discloses a Connection Manager to selectively invoke when an application on a computing host opens a designated gateway communications port. Any application that opens the gateway port and which has a preexisting entry in a special applications database will result in the appropriate target communications port being transparently selected, attributed, and configured. The application becoming automatically connected to the desired target device. Connections may be wired or wireless. The Connection Manager provides a straightforward and uniform way to automatically manage (including configuration and reconfiguration) ports and devices for communication applications executing on the computing host.

U.S. Patent Application 2005/0176473 generally discloses a wireless network driver software architecture named Multi-standard Wireless Adaptation Layer (MWAL). The MWAL is for client devices that may be portable, need to efficiently switch from one wireless standard to another and that must be able to stay connected and reachable in the Internet or other IP based network even when switching between wireless communication standards. The technique of the disclosure is a layer two technique suitable for vertical markets and proprietary solutions, in which the MWAL enables the client device to perform vertical handovers between wireless communications standards.

### SUMMARY

In at least one embodiment, a vehicle computing system comprising at least one processor in communication with a nomadic device via a transceiver. The processor may be programmed and configured to execute a first application when a communication link with the nomadic device is established. The processor may be further configured to communicate with a second application being executed at the nomadic device. The processor may be further configured to monitor the communication link with the nomadic device for termination of the communication link. The processor may be further configured to disable the first application upon termination of the communication link with the nomadic device.

In at least one embodiment, a computer readable storage medium, storing instructions, which, when executed by a processor, cause the processor to shutdown one or more applications based on a terminated communication link. The method may comprise monitoring a communication link with a vehicle computing system with a first application. The method may further comprise detect a second application transmitting a terminate message instructing shutdown of the first application utilizing the communication link based upon detecting a disconnection of the communication link.

In at least one embodiment, a mobile device comprising at least one processor in communication with a transceiver. The transceiver may be configured to communicate with a vehicle computing system. The processor may be programmed and configured to establish a communication link with the vehicle computing system. The processor may be further configured to execute an application based on the communication with the vehicle computing system. The processor may be further configured to transmit at least a portion of data to the vehicle computing system via the communication link. The processor may be further configured to monitor the communication link with the vehicle computing system for a termination of the communication link. The processor may be further configured to transmit a disable message to the application if the communication link is terminated.

### BRIEF DESCRIPTION OF THE DRAWINGS

FIG. 1 is an exemplary block topology of a vehicle infotainment system implementing a user-interactive vehicle information display system according to an embodiment;

FIG. 2 is an exemplary block topology of a system for integrating one or more connected devices with the vehicle based computing system according to an embodiment;

FIG. 3 is a flow chart illustrating an example method of a nomadic device disabling one or more applications; and

FIG. 4 is a flow chart illustrating an example method of a vehicle computing system disabling one or more applications.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

This invention disclosure proposes a system and method to automatically close an application during a transport disconnect. For example, an application may be only useful while connected to a vehicle computing system, or may become unwanted after a communication disconnection from the vehicle computing system. When disconnecting a wireless device executing the application from the vehicle computing system, the application may often continue to run, sometimes with unintended consequences. This may cause problems at the vehicle computing system and/or at the wireless device (e.g., nomadic device).

The disclosure enables a method and system for automatically closing an application when disconnecting a communication link with the vehicle computing system from an application no matter the transport. This may be applied on either the vehicle computing system, a connected nomadic device, and/or a combination thereof when the communication link is disconnected. The one or more applications on the nomadic device may have several states of operation including, but not limited to, enabled running in the foreground, enabled running in the background, and/or disabled. The application state of operation may determine whether the vehicle computing system may receive data once communication is established with the nomadic device.

The vehicle computing system may require that the application on the smartphone be enabled and running in the foreground such that the system may communicate with the application. For example, if the nomadic device, such as a smartphone, establishes communication with the vehicle computing system, the application(s) that is either in the background and/or disabled on the smartphone may not communicate data with the vehicle computing system. The one or more applications running in the foreground at the nomadic device may communicate with the vehicle computing system and may continue to perform execution of functions after the communication link is disabled. The application that continues to run at either the nomadic device and/or the vehicle computing system may cause unintended data to be executed once the communication link has ended.

The method and system for disabling an application on the nomadic device once communication with the vehicle computing system has been disconnected may be disclosed in this document. The vehicle computing system includes one or more applications executed on the hardware of the system to communicate with the nomadic device. The vehicle computing system may communicate with the nomadic device based on one or more wireless and wired technologies. This disclosure may allow for the vehicle computing system and/or the nomadic device to provide a means disabling one or more applications once communication between the two components has ended. This disclosure may also allow for the vehicle computing system and/or nomadic device to automatically disable the application(s) via a notification message from the vehicle computing system.

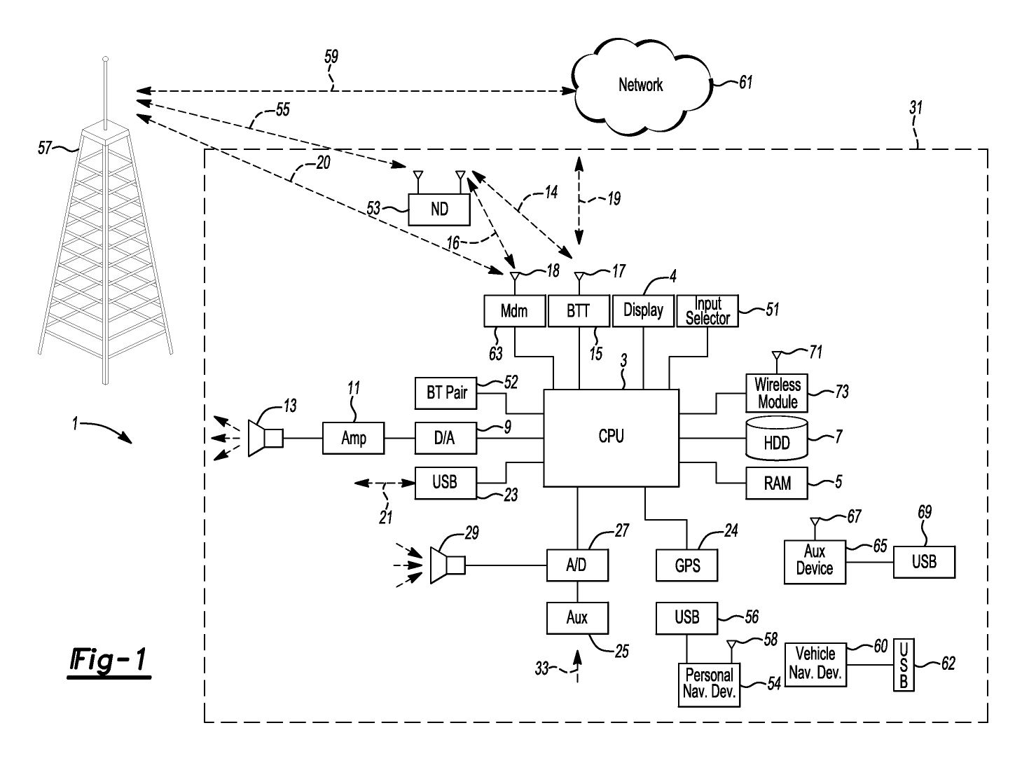

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

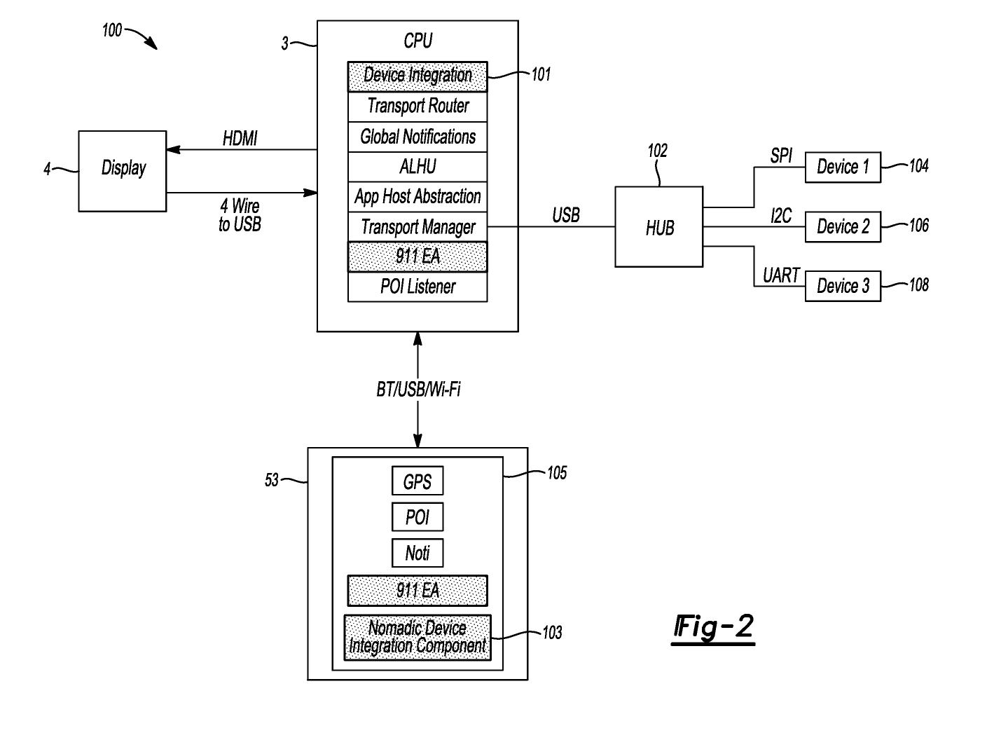

FIG. 2 is an exemplary block topology of a system 100 for integrating one or more connected devices with the vehicle based computing system 1 (VCS). The CPU 3 may be in communication with one or more transceivers. The one or more transceivers are capable for wired and wireless communication for the integration of one or more devices. To facilitate the integration, the CPU 3 may include a device integration framework 101 configured to provide various services to the connected devices. The device integration framework 101 may include, but is not limited to, an application management program to monitor the interaction of one or more applications with remote devices in communication with the VCS 1. These services may include transport routing of messages between the connected devices and the CPU 3, global notification services to allow connected devices to provide alerts to the user, application launch and management facilities to allow for unified access to applications executed by the CPU 3 and those executed by the connected devices, application disable management based on a disconnection of a communication link, and point of interest location and management services for various possible vehicle 31 destinations.

For example, the nomadic device 53 may establish a communication link with the VCS 1. The nomadic device 53 may execute one or more applications on hardware (e.g., processor, etc.) 105 at the device. The nomadic device 53 may transmit at least a portion of data associated with the one or more applications to the VCS 1 via the communication link. In response to the one or more applications being executed at the nomadic device 53, the VCS 1 may also enable and execute one or more applications associated with the nomadic device application(s). The VCS 1 may receive at least a portion of data being generated by the one or more applications executed at the nomadic device 53. The VCS 1 may output data to a user based on the received data from the nomadic device 53.

In one embodiment, the nomadic device 53 may have a navigation application being executed at the device. The VCS 1 may have an application related to the navigation application being executed at the nomadic device 53. The navigation application data may be transmitting to the related VCS 1 application via the communication link. If the communication link is disabled, the navigation application may continue to be executed at the nomadic device 53 and VCS 1. The unintended execution of data may cause unnecessary processing resources at the nomadic device 53 and VCS 1. Therefore the unnecessary processing resources may cause performance issues at the VCS 1 based on the processor task manager looking to receive additional data from the nomadic device 53. The unintended execution of data at the nomadic device 53 may cause the processing performance to decrease, unnecessary data to be transmitted to the user, and/or a potential decrease in battery life based on the unnecessary usage of processing resources.

There are several scenarios that may cause continued execution of the navigation application at the nomadic device 53 once communication with the VCS 1 is disabled. For example, the nomadic device 53 disconnects from the VCS 1 by a user exiting the vehicle with the nomadic device. The nomadic device 53 may remain in the user's pocket or purse. The mobile application continues to use resources such as consuming streaming data for the navigation/map application(s), and consuming battery life for the application that the user is no longer interacting with. Not only may this happen without the user's knowledge, but even if the user is aware of the problem, it may create an additional set of actions for the user to perform for disabling the application. For example, the user may have to take the nomadic device 53 out of their pocket or purse, unlock the nomadic device 53, browse to the application, terminate the application, relock the nomadic device 53, and/or restore the nomadic device 53 to his or her pocket or purse.

In another example, a nomadic device 53 may be disconnected from the VCS 1 by a user requesting a disconnection command at the VCS 1. The nomadic device application may be unsure of the intention of the disconnection command received from the VCS 1 and may try to resolve a “temporary” transport disconnection by reconnecting to the VCS 1, which is an undesired action being taken by the device. In another example, the nomadic device application may continue to stream data and output information at the device. The management of application(s) at the nomadic device during vehicle operation may cause annoyance and/or a distraction to the vehicle occupants, therefore the need to have the application(s) disabled during a communication disconnect with the VCS may improve the driving experience.

As mentioned above, the CPU 3 (i.e., processor) of the VCS 1 may be configured to interface with one or more nomadic devices 53 of various types. The nomadic device 53 may further include a device integration client component 103 to allow the nomadic device 53 to take advantage of the services provided by the device integration framework 101. The device integration client component 103 may include, but is not limited to, an application management program to monitor the interaction of one or more applications with the VCS 1. These services may include transport routing of messages between the VCS 1 and the device 53, application launch and management facilities to allow for unified access to applications executed by the VCS 1 and the nomadic device processor, and/or an application disable management based on a disconnection of a communication link with the VCS 1.

The one or more transceivers may include a multiport connector hub 102. The multiport connector hub 102 may be used to interface between the CPU 3 and additional types of connected devices other than the nomadic devices 53. The multiport connector hub 102 may communicate with the CPU 3 over various buses and protocols, such as via USB, and may further communicate with the connected devices using various other connection buses and protocols, such as Serial Peripheral Interface Bus (SPI), Inter-integrated circuit (I2C), and/or Universal Asynchronous Receiver/Transmitter (UART). The multiport connector hub 102 may further perform communication protocol translation and interworking services between the protocols used by the connected devices and the protocol used between the multiport connector hub 102 and the CPU 3. The connected devices may include, as some non-limiting examples, a radar detector 104, a global position receiver device 106, and a storage device 108.

For example, the radar detector 104 may establish communication to the VCS 1 via the multiport connector hub 102. The VCS 1 may enable one or more applications based on the communication with the radar detector 104. For example, the VCS 1 may output information to a user interface based on the received data from the radar detector 104. If the radar detector 104 communication link with the VCS 1 is disconnected, the VCS 1 may continue to look for additional data from the radar detector 104. The VCS 1 may monitor the communication link with the radar detector 104 and if a disconnection is detected the VCS 1 may disable the associated radar application(s). The one or more applications executed at the VCS 1 and associated with the radar detector 104 may be disabled automatically without user interaction.

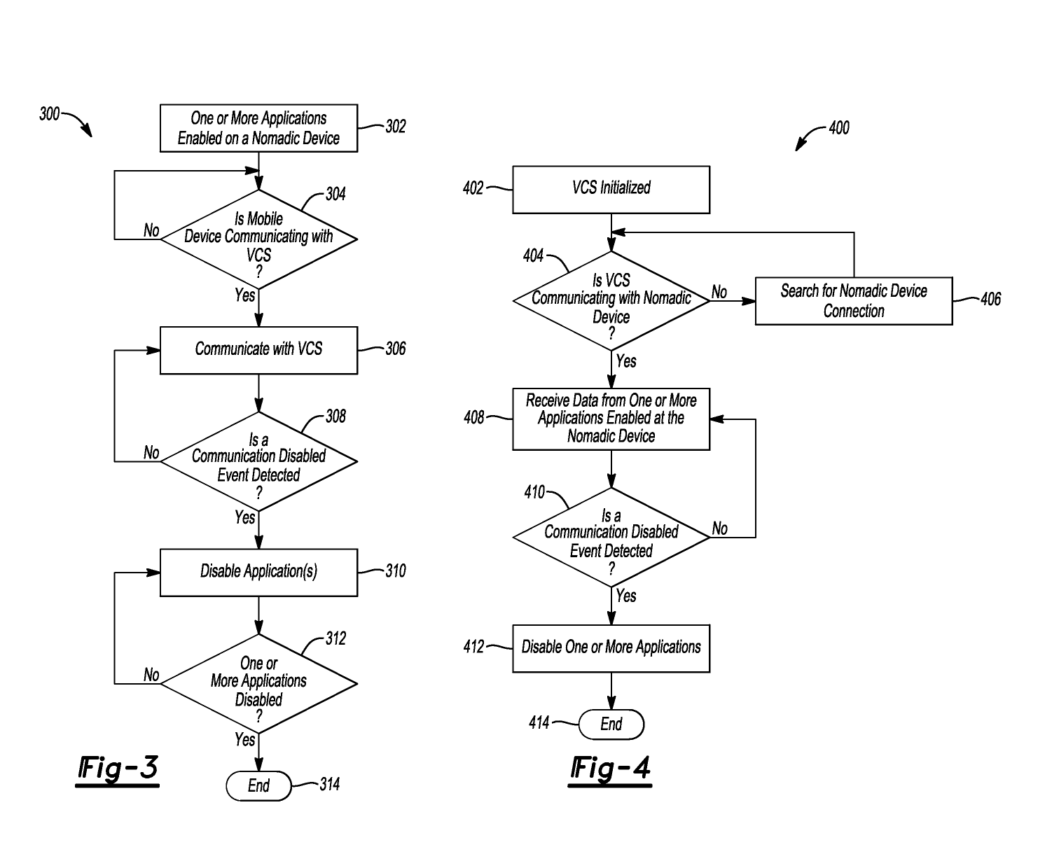

FIG. 3 is a flow chart illustrating an example method of the nomadic device disabling one or more applications. The method 300 may be implemented using software code contained at the nomadic device processor. In other embodiments, the method 300 may be implemented in the nomadic device processor, distributed amongst multiple processors at the nomadic device, and/or at a remote server in communication with the nomadic device.

Referring again to FIG. 3, the nomadic device and its components illustrated in FIG. 2 are referenced throughout the discussion of the method to facilitate understanding of various aspects of the present disclosure. The method 300 of monitoring communication with the VCS 1 and disabling feature/function/service applications if the communication link is disabled may be implemented through a computer algorithm, machine executable code, or software instructions programmed into a suitable programmable logic device(s) of the nomadic device, such as the nomadic device processor, a remote server in communication with the nomadic device, or a combination thereof. Although the various operations shown in the flowchart diagram 300 appear to occur in a chronological sequence, at least some of the operations may occur in a different order, and some operations may be performed concurrently or not at all.

In operation 302, the nomadic device may have one or more applications executed on hardware of the device. The one or more applications may include, but is not limited to, internet radio, navigation, social media, and/or other internet services. The one or more applications may be configured to be communicated to the VCS via an application program interface (API).

In operation 304, the nomadic device may establish communication with the VCS using one or more transport communications methods and/or protocols. For example, the nomadic device may establish communication with the VCS using Bluetooth Low Energy (BLE). Once communication has been established, after one or more security handshakes and/or pairing the device, the nomadic device may communicate data to the VCS in operation 306.

For example, once communication has been establish with the VCS via BLE, the nomadic device may execute one or more applications configured to communicate with the VCS. The one or more applications may include an internet radio application. The internet radio application may provide data to the VCS including, but not limited to, music data, music information, music art, and/or a combination thereof. The VCS may output this data to one or more components including an LCD screen, a speaker, and/or a combination thereof.

In another example, the one or more applications being executed at the nomadic device may receive data from the VCS. The data from the VCS may include, but is not limited to, user input via VCS interface controls. Continuing from the internet radio application example, the VCS may transmit control commands including, but not limited to, play, pause, skip, song selection, and/or a combination thereof.

In operation 308, the nomadic device may monitor the communication link with the VCS. For example, the nomadic device operating system may send a signal based on the disconnection of the communication link to the nomadic application, which must register for/listen for this signal and act upon it.

In another example, the method to determine whether to shutdown/disable an application may be described as a “heartbeat” or a “ping” system. The nomadic application periodically tries to send a short message in-band to the VCS via a transport/communication channel. The method may require receiving a corresponding message back from the VCS before a certain timeout period has elapsed, or the communication is assumed to be disconnected. The method may further include monitoring the success of the “send” action alone. If the message (or a small number of consecutive messages) is unable to be sent out from the nomadic device, the transport is understood to be disconnected. This may be a lightweight, portable, accurate, and generic way of monitoring the status of the connection without relying on specific messages from the mobile operating system or a specific implementation on the VCS that can respond in a specified manner.

In operation 310, if the nomadic device determines that the communication with the VCS has been lost, the nomadic device may disable one or more applications transmitting data to the VCS. The nomadic device may transmit a disable message to the application that was in communication with the VCS.

In one example, the user may wish for the application to remain running at the nomadic device after communication has been disabled with the VCS. If the user requires the application to remain running after communication is disabled with the VCS, the method may enable this to be handled on an application-by-application basis. In other words, a specific application may either choose to ignore all shutdown signals, or it may provide an option for the user to disable/enable the feature.

In operation 312, the one or more application at the nomadic device may be disabled based on the disabled communication link with the VCS. In another example, if a VCS requests a power down (e.g., key-off event) of the vehicle, the VCS may transmit a disable message to the nomadic device. The nomadic device may receive the disable message comprising instructions to disable the one or more applications in communication with the VCS.

In operation 314, if a request is generated to disable the one or more applications at the nomadic device, the device may store one or more application settings, data, and/or other preconfigured information in correlation with the VCS in nonvolatile memory and/or at a remote server.

FIG. 4 is a flow chart illustrating an example method of a vehicle computing system disabling one or more applications. The method 400 may be implemented using software code contained within the VCS 1. In other embodiments, the method 400 may be implemented in other vehicle controllers, or distributed amongst multiple vehicle controllers.

Referring again to FIG. 4, the vehicle and its components illustrated in FIG. 1, and FIG. 2, are referenced throughout the discussion of the method to facilitate understanding of various aspects of the present disclosure. The method 400 of monitoring communication with the nomadic device 53 and disabling a feature/function/service application if the communication link with the nomadic device is disabled may be implemented through a computer algorithm, machine executable code, or software instructions programmed into a suitable programmable logic device(s) of the vehicle, such as the vehicle control module, the device control module, another controller in communication with the vehicle computing system, or a combination thereof. Although the various operations shown in the flowchart diagram 400 appear to occur in a chronological sequence, at least some of the operations may occur in a different order, and some operations may be performed concurrently or not at all.

In operation 402, the VCS may initialize one or more applications for execution based on a start request, communication established with the nomadic device, and/or a combination thereof. The VCS may be enabled by a start request received from one or more mechanisms including, but not limited to, a vehicle key, a vehicle key fob, a wireless device, and/or a combination thereof.

In operation 404, the VCS may comprise one or more transceivers for establishing communication with one or more remote devices. The remote devices may include, but is not limited to, the radar detector, the nomadic device (i.e., smartphone), and/or the global position device. The VCS may exchange one or more security handshakes with the nomadic device before communication is enabled. For example, the VCS may require that the nomadic device be paired before establishing communication with the VCS. The VCS may continuously search for the nomadic device connection in operation 406.

In operation 408, the VCS may receive data from one or more applications executed at the nomadic device and/or remote device. For example, the VCS may detect a global positioning application executed at the nomadic device and launch the associated application at the VCS. The VCS application may receive at least a portion of data from the global positioning application executed at the nomadic device. The VCS application may output the received data to one or more components (e.g., a display, a speaker, etc.).

In operation 410, the VCS may monitor the communication link with the nomadic device. For example, the VCS may determine if the application data is being received based on the monitoring of one or more communication variables. In another example, the one or more associated applications at the VCS may be configured to receive a feedback signal from the nomadic device within a predetermined time period to determine whether the communication link is established or disabled.

For example, the method to determine whether to shutdown/disable an application may be described as a “heartbeat” or a “ping” system for the VCS. The VCS application periodically tries to send a short message out to the nomadic device. The VCS may require receiving a corresponding message back from the nomadic device before a certain timeout period has elapsed, or the communication is assumed to be disconnected. The method may further include monitoring the success of the “send” action alone. If the message (or a small number of consecutive messages) is unable to be sent out from the VCS, the transport is understood to be disconnected.

In operation 412, if the VCS determines that the communication with the nomadic device has been lost, the VCS may disable one or more applications associated with the nomadic device applications. The VCS may transmit a disable message to the application(s) in communication with the nomadic device.

In one example, the VCS may be configured to continue to execute the VCS application after communication has been disabled with the nomadic device. The VCS may determine whether or not the application may be executed without communication from the nomadic device, this may be handled on an application-by-application basis. In another example, the VCS may be designed to entirely rely on mobile connectivity, therefore the VCS action may be as simple as displaying a screen or notice to please connect the nomadic device.

In operation 414, if a request is received from the nomadic device to disable the one or more applications at the VCS, the system may store one or more application settings, data, and/or other preconfigured information in correlation with the nomadic device application in nonvolatile memory and/or at a remote server. The one or more applications at the VCS may be disabled based on the disconnected communication link with the nomadic device. In another example, if the VCS is in a power down state (e.g., key-off event), the VCS may transmit a disable message to the nomadic device to disable one or more applications executed at the device. The disable message may comprise instructions to disable the nomadic device application(s) in communication with the VCS while storing configuration and settings in non-volatile memory.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle computing system comprising:
at least one processor in communication with a nomadic device via a transceiver, the processor programmed and configured to:
execute a first application when a communication link with the nomadic device is established;
communicate with a second application executed at the nomadic device;
monitor the communication link with the nomadic device for termination of the communication link; and
disable the first application upon termination of the communication link with the nomadic device.

2. The vehicle computing system of claim 1, wherein the first application is a vehicle navigation application.

3. The vehicle computing system of claim 2, wherein the second application is a mobile navigation application configured to communicate with the vehicle navigation application.

4. The vehicle computing system of claim 3, wherein the at least one processor is further configured to transmit a disable message to the mobile navigation application based on a vehicle computing system shutdown request.

5. The vehicle computing system of claim 4, wherein the disable of the first application is at least one of a background run request and a disable request.

6. The vehicle computing system of claim 1, wherein the termination of the communication link is based on a signal that is transmitted in periodic intervals to the nomadic device and a corresponding message is not received by the at least one processor within a predefined amount of time.

7. The vehicle computing system of claim 1, wherein the at least one processor is further configured to output a message to notify the termination of the communication link.

8. A mobile device comprising:
at least one processor in communication with a transceiver, the transceiver configured to communicate with a vehicle computing system, the processor programmed and configured to:
establish a communication link with the vehicle computing system;
execute an application based on the communication with the vehicle computing system;
transmit at least a portion of data to the vehicle computing system via the communication link;
monitor the communication link with the vehicle computing system for a termination of the communication link; and
if the communication link is terminated, transmit a disable message to the application.

9. The mobile device of claim 8, wherein the at least one processor is further programmed to periodically send a ping message to the vehicle computing system to monitor the communication link, and determine the communication link is terminated if the ping message fails within a predefined amount of time.

10. The mobile device of claim 8, wherein the application is an internet radio application and is configured with an application programming interface to communicate with the vehicle computing system.

11. The mobile device of claim 10, wherein the vehicle computing system is configured to receive at least a portion of data from the internet radio application and output the data to one or more components.

12. The mobile device of claim 8, wherein the at least one processor is further configured to receive the disable message from the vehicle computing system based on a key-off event at a vehicle.

13. A computer readable storage medium, storing instructions, which, when executed by a processor, cause the processor to:
monitor a communication link with a vehicle computing system with a first application;
detect with a second application a disconnection of the communication link; and
transmit a termination message from the second application to the first application, wherein the termination link instructs shutdown of the first application.

14. The computer readable storage medium of claim 13, wherein the termination message is a preconfigured signal and the first application is registered to receive the preconfigured signal.

15. The computer readable storage medium of claim 13, wherein the termination message is based on a ping message sent within a predetermined amount of time to the vehicle computing system to monitor if the communication link is disabled.

16. The computer readable storage medium of claim 13, wherein the first application is configured to include an application program interface associated with the vehicle computing system.

17. The computer readable storage medium of claim 13, wherein the termination message is at least one of a background running request and a disabling request.

18. The computer readable storage medium of claim 13, wherein the communication link is at least one of a wired connection and a wireless connection.

19. The computer readable storage medium of claim 18, wherein the wired and wireless connection is at least one of an universal serial bus connection, Bluetooth, Bluetooth Low Energy, Wi-Fi Direct, and Wi-Fi.

20. The computer readable storage medium of claim 13, wherein the processor is embedded on a smartphone device.
